(19) United States
(12) Patent Application Publication
(10) Pub. No.: US 2026/0308364 A1
(43) Pub. Date: Oct. 8, 2026

(54) THERMOPLASTIC STARCH FORMULATIONS WITH ADDITIVES FOR PERFORMANCE ENHANCEMENTS

(71) Applicant: BiologiQ, Inc., Idaho Falls, ID (US)

(72) Inventors: Kanth V. Josyula, Richmond, TX (US); Wenji Quan, Idaho Falls, ID (US); Fehime Vatansever Ozaltun, Idaho Falls, ID (US); Kurtis R. Clark, Idaho Falls, ID (US); David J. Fairbanks, Idaho Falls, ID (US); Leopoldo V. Cancio, Vero Beach, FL (US); Kenneth L. Kramer, Columbus, IN (US)

(21) Appl. No.: 19/706,498

(22) Filed: Jun. 12, 2026

Related U.S. Application Data
(62) Division of application No. 18/492,611, filed on Oct. 23, 2023.
(60) Provisional application No. 63/418,852, filed on Oct. 24, 2022.
(60) Provisional application No. 63/381,396, filed on Oct. 28, 2022.
(60) Provisional application No. 63/428,283, filed on Nov. 28, 2022.

(51) Int. Cl. C08L 3/02; C08K 5/06; C08K 5/092; C08K 5/1545

(52) U.S. Cl. CPC C08L 3/02; C08K 5/06; C08K 5/092; C08K 5/1545

(57) ABSTRACT

Thermoplastic starch-based materials formed as a reactive extrusion product from one or more starches, plasticizers, with the addition of a diacid, diglycidyl ether, silicone and/or a glyceride additive added during gelatinization of the starch and plasticizer, before blending of such starch-based polymeric material with any other polymer (e.g., polyester biopolymers, polyolefins, polyamides, etc.). Silicones, where added, may alternatively be added after formation of the thermoplastic starch, e.g., as part of a masterbatch, when blending with another polymer. Addition of silicone reduces glycerin migration and smoke generation, particularly when processing such compositions to form nonwovens. Addition of glycerides (e.g., triglycerides) can increase hydrophobicity of the resulting starch-based polymeric material. Addition of the diacid can reduce molecular weight, while diglycidyl ether addition can build such molecular weight back up, resulting in a narrower molecular weight distribution, and improved processability of the resulting starch-based polymeric material, particularly for nonwoven applications.

### CROSS-REFERENCE TO RELATED APPLICATIONS

This application is a divisional of U.S. patent application Ser. No. 18/492,611 filed on Oct. 23, 2023, and entitled “THERMOPLASTIC STARCH FORMULATIONS WITH ADDITIVES FOR PERFORMANCE ENHANCEMENTS,” which claims the benefit of and priority to: (i) U.S. Provisional Patent Application Ser. No. 63/418,852 filed on Oct. 24, 2022, and entitled “THERMOPLASTIC STARCH FORMULATIONS WITH ADDITIVES THAT IMPART HYDROPHOBICITY, ADDRESS PLASTICIZER MIGRATION AND IMPROVE PROCESSABILITY”; (ii) U.S. Provisional Patent Application Ser. No. 63/381,396 filed on Oct. 28, 2022, and entitled “THERMOPLASTIC STARCH FORMULATIONS WITH ADDITIVES FOR MOLECULAR WEIGHT CONTROL AMENABLE FOR NONWOVEN, FIBER AND ADHESIVE APPLICATIONS, WITH REDUCED SMOKE”; and (iii) U.S. Provisional Patent Application Ser. No. 63/428,283 filed on Nov. 28, 2022, and entitled “THERMOPLASTIC STARCH FORMULATIONS WITH NANO PARTICLES OR FIBER ADDITIVES TO IMPART IMPROVED PROPERTIES FOR FILMS AND ARTICLES”, each of which is expressly incorporated herein by reference in its entirety.

The present application incorporates by reference each of U.S. application Ser. No. 17/573,403 (21132.32.1), filed Jan. 11, 2022, U.S. application Ser. No. 17/327,536 (21132.31.1) filed May 21, 2021, U.S. application Ser. No. 17/327,577 (21132.31.2) filed May 21, 2021, U.S. application Ser. No. 17/327,590 (21132.31.3) filed May 21, 2021, U.S. application Ser. No. 16/925,747 (21132.30.1), filed Jul. 10, 2020 (now U.S. Pat. No. 11,674,014); U.S. application Ser. No. 16/925,952 (21132.28.1.1) filed Jul. 10, 2020 (now U.S. Pat. No. 11,359,088); U.S. application Ser. No. 16/925,705 (21132.27.1.1) filed Jul. 10, 2020 (now U.S. Pat. No. 11,674,018); U.S. patent application Ser. No. 16/425,397 (21132.20.1) filed May 29, 2019 (now U.S. Pat. No. 11,149,144); U.S. patent application Ser. No. 16/391,909 (21132.14.1) filed Apr. 23, 2019 (now U.S. Pat. No. 11,111,355); U.S. application Ser. No. 15/456,295 (21132.12.1) filed Jun. 28, 2019 (now U.S. Pat. No. 10,920,044), U.S. application Ser. No. 15/691,588 (21132.7) filed on Aug. 30, 2017 (now U.S. Pat. No. 11,046,840); U.S. application Ser. No. 14/853,725 (21132.8) filed on Sep. 14, 2015 (now abandoned); U.S. Provisional Patent Application No. 62/187,231 filed on Jun. 30, 2015; U.S. application Ser. No. 14/853,780 (21132.6) filed on Sep. 14, 2015 (now abandoned); U.S. application Ser. No. 15/481,806 (21132.1) and Ser. No. 15/481,823 (21132.2), both filed on Apr. 7, 2017 (now U.S. Pat. Nos. 10,995,201 and 10,919,203, respectively); U.S. Provisional Patent Application No. 62/440,399 (21132.10) filed on Dec. 29, 2016; U.S. Provisional Patent Application No. 62/442,432 (21132.11) filed on Jan. 4, 2017; U.S. application Ser. No. 16/456,303 (21132.9.1) filed on Jun. 28, 2019 (now U.S. Pat. No. 10,752,759); and U.S. patent application Ser. No. 15/836,555 (21132.4.1), filed Dec. 8, 2017 (now U.S. Pat. No. 11,111,363).

### BACKGROUND

Traditional petrochemical-based plastics are formulated to be strong, lightweight, and durable. For this reason, they are used in large quantities in countless consumer products. However, these plastics are generally not sourced from sustainable materials, are typically not biodegradable to any significant extent, and as a result, hundreds of millions of tons of plastic persists in landfills or in other natural environments (oceans, other waterways, in soil, etc.). In trying to reduce the amount of plastic waste, some articles typically produced using petrochemical-based plastics are being produced using more rapidly biodegradable materials, and/or from a fraction of components sourced from renewable sources.

Starch is widely recognized as a plant-based biopolymer extensively used as a filler in other polymers. However, when combined with other bio-polymers or fossil fuel or synthetic based polymers in amounts greater than about 5%, it tends to dramatically reduce strength and other important physical properties of the base polymer. This is typically attributed to the crystalline nature of starch and its incompatibility with other polymers. In an effort to address such issues, starch can be gelatinized with a plasticizer and/or water to convert crystalline starch to more amorphous, thermoplastic starch (TPS). However, this process typically results in a dramatic reduction in the molecular weight of the resulting starch-based material, and the resulting blends and films and other articles formed therefrom still continue to exhibit generally inferior mechanical properties, as compared to use of the base resin alone. In addition, many such thermoplastic starches are not stable, but tend to revert back towards their initial crystalline structure over time, further exacerbating such problems.

Also, for nonwoven applications, such as fiber, spunbond, meltblown and adhesive applications, properties such as molecular weight, molecular weight distribution, and viscosity play a major role. For example, polypropylenes are widely used in current nonwoven applications, however, not all polypropylenes can be used for such applications as they need specific rheological properties to be able to form fibers or make such compositions spinnable.

Applicant's applications and patents as incorporated by reference above disclose starch-based polymeric materials (e.g., thermoplastic starch materials) that can be blended with various plastic resin materials, while substantially maintaining desired strength and other physical characteristics of the material with which the renewable starch-based material is blended. Such starch-based materials, available under the tradename NuPlastiQ, are theorized to achieve a strong intermolecular bond between the starch-based material, and the plastic resin with which it is blended. Such strong bonding is in contrast to what is achieved in numerous prior art attempts to blend such plastic resins with starch or starch-based materials. NuPlastiQ also tends to resist recrystallization or retrogradation back to a crystalline structure.

Earlier, applicant identified certain thermoplastic starch/polypropylene and other blends that are amenable to nonwoven applications, e.g., as described in applicant's U.S. application Ser. No. 17/327,536 (21132.31.1), U.S. application Ser. No. 17/327,577 (21132.31.2), and U.S. application Ser. No. 17/327,590 (21132.31.3), already incorporated by reference. As the thermoplastic starch viscosity and rheological properties are essential for success in fiber forming or spinning processes, a limited variety of starches were suitable for such applications. Even with the advances described in applicant's previous applications, there are areas where further improvements could be achieved.

### SUMMARY

An exemplary thermoplastic starch-based material according to the present invention is formed (e.g., within an extruder, compounder, or similar system) from one or more starches, one or more plasticizers, and a diacid or corresponding acid anhydride additive. Other additives as described herein may additionally or alternatively be present. As used herein, the term extruder is to be construed broadly, to include extruders and similar systems, such as, but not limited to other compounding systems, such as a Banbury mixing system, a multiple rolls mill, and/or a Farrel continuous mixer.

Another exemplary thermoplastic starch-based material according to the invention is formed (e.g., within an extruder, compounder, or similar system) from one or more starches, the starches being present in an amount of from about 50% to 85%, or from 65% to about 85% by weight of the starch-based material, one or more plasticizers (e.g., at least one of glycerin, sorbitol, maltitol or propane diol), the one or more plasticizers being present in an amount of from about 10% to about 30%, or from 15% to about 30% by weight of the starch-based material. A diacid or corresponding acid anhydride is also present, in an amount of from about 0.1% to about 5% by weight of the starch-based material. A glycidyl ether (e.g., diglycidyl ether) may optionally be present, e.g., in an amount of from about 0.1% to about 5% by weight of the starch-based material. The foregoing percentages of starch, plasticizer and additives may be on a “dry” basis, excluding any water that may be present. While the finished starch-based material may generally exhibit a very low water content, of less than 2%, or even less than 1% by weight, a significant amount of water may be present initially, when mixing the various components, as introduced into the extruder or other system. For example, the water content at such initial stage may be from about 10% to about 25% by weight, of the mixture. Nearly all of such water is driven off during reactive extrusion, resulting in the finished starch-based polymeric material.

Another exemplary thermoplastic starch-based material according to the invention is formed (e.g., within an extruder, compounder, or similar system) from one or more starches, the starches being present in an amount of from about 50% to about 85%, or from about 65% to about 85% by weight of the starch-based material, one or more plasticizers (e.g., at least one of glycerin, sorbitol, maltitol or propane diol), the one or more plasticizers being present in an amount of from about 10% to about 30%, or from about 15% to about 30% by weight of the starch-based material. At least one of (i) a silicone, e.g., present in an amount of from about 0.1% to about 5% by weight of the starch-based material, or (ii) a glyceride (e.g., a mono, di or triglyceride including one or more fatty acid chain residues) present in an amount of from about 1% to about 10% by weight is also present. The glyceride component may provide the thermoplastic starch-based material with increased hydrophobicity, while the silicone component may provide the thermoplastic starch-based material with decreased smoke generation during formation of melt spun fibers and nonwovens from such thermoplastic starch-based material. The use of sorbitol as the plasticizer, as opposed to glycerin, can also reduce or eliminate such smoke issues.

In any of the described embodiments, exemplary plasticizers may particularly include glycerin, sorbitol, maltitol, or propane diol. Additional exemplary plasticizers that may be used include, but are not limited to polyethylene glycol, polyhydric alcohol plasticizers, hydrogen bond forming organic compounds which do not have a hydroxyl group, anhydrides of sugar alcohols, animal proteins, vegetable proteins, aliphatic acids, phthalate esters, dimethyl and diethylsuccinate and related esters, glycerol triacetate, glycerol mono and diacetates, glycerol mono, di, and tripropionates, butanoates, stearates, lactic acid esters, citric acid esters, adipic acid esters, stearic acid esters, oleic acid esters, or other acid esters. Combinations of different plasticizers may be used.

In any of the described embodiments, the one or more plasticizers comprises sorbitol and are substantially or entirely free of glycerin. In an embodiment, the plasticizer may consist of sorbitol.

In any of the described embodiments, the diacid or corresponding acid anhydride may be present in an amount of from about 0.01% to about 5% by weight of the starch-based material.

In any of the described embodiments, the diacid or corresponding acid anhydride may be present in an amount of no more than about 0.5% by weight of the starch-based material.

In any of the described embodiments, the diacid or corresponding acid anhydride is present in an amount of from about 0.2% to about 0.3% by weight of the starch-based material.

In any of the described embodiments, any included diacid or acid anhydride is not included as a modified polymer, where such a structure is grafted onto the polymer, e.g., such as acid anhydride modified polymers sometimes used as compatibilizers when blending thermoplastic starches with partner resins. The included diacids or acid anhydrides are low molecular weight “free” compounds, not grafted onto a polymer or other backbone. For example, such structures typically have molecular weight values of less than 1000 g/mol, less than 500 g/mol, or less than 300 g/mol. These additives are added with the starch, plasticizer and water in the absence of any polymer components, other than the starch, during reactive extrusion formation of the starch-based material. The same may be stated for any of the other additive materials added during reactive extrusion formation (i.e., they are not present as grafted moieties on a polymer or similar backbone, but as “free” compounds.

In any of the described embodiments, a glycidyl ether (e.g., diglycidyl ether) may be included.

In any of the described embodiments, the glycidyl ether or diglycidyl ether may be present in an amount of from about 0.1% to about 5% by weight of the starch-based material.

In any of the described embodiments, the glycidyl ether or diglycidyl ether is present in an amount of no more than about 0.5% by weight of the starch-based material.

In any of the described embodiments, the glycidyl ether or diglycidyl ether is present in an amount of from about 0.2% to about 0.3% by weight of the starch-based material.

In any of the described embodiments, the thermoplastic starch-based material may be blended with at least one of PLA, PBAT, PBS, PHA, another polyester, a polyamide, a polyolefin or polystyrene. It will be apparent that the foregoing is not an exhaustive listing, and numerous other polymer resins may be blended with the thermoplastic starch-based material.

In any of the described embodiments, the starch-based material may include at least one of a diacid or corresponding acid anhydride (e.g., present in an amount of from about 0.2% to about 0.3% by weight of the starch-based material) and/or a glycidyl ether (e.g., a diglycidyl ether), e.g., present in an amount of from about 0.2% to about 0.3% by weight of the starch-based material.

In any of the described embodiments, the thermoplastic starch-based material may include less than 2%, less than 1%, or less than 0.8% water content. Such water content may be somewhat or significantly lower than previous NuPlastiQ formulations prepared by Applicant, e.g., attributable to the diacid or corresponding acid anhydride that is present. For example, many previous NuPlastiQ formulations included less than 2% water content, such as from 1% to 2%, or from 1% to 1.5% water content.

In any of the described embodiments, a silicone may be present (e.g., in an amount of from about 0.1% to about 5% by weight of the starch-based material). Addition of such a silicone may provide the thermoplastic starch-based material with decreased smoke generation during formation of melt spun fibers and nonwovens from such thermoplastic starch-based material. The use of sorbitol as the plasticizer, particularly while limiting or eliminating the use of glycerin as a plasticizer, may also aid in eliminating or reducing smoke generation during such processing.

In any of the described embodiments, a glyceride may be present (e.g., in an amount of from about 1% to about 10% by weight). Such a glyceride component may provide the thermoplastic starch-based material with increased hydrophobicity.

In any of the described embodiments, the glyceride comprises a triglyceride.

In any of the described embodiments, the glyceride comprises a fatty acid chain residue.

In any of the described embodiments, a diacid or corresponding acid anhydride, and/or a glycidyl ether or diglycidyl ether may be present, e.g., in an amount of from about 0.01% to about 5%, or from about 0.1% to about 0.5% by weight of the starch-based material.

In any of the described embodiments, (i) a diacid or corresponding acid anhydride, and (ii) a glycidyl ether or diglycidyl ether may each be present in an amount of from about 0.01% to about 5% by weight of the starch-based material.

Features from any of the disclosed embodiments may be used in combination with one another, without limitation. For example, any of the compositional or other limitations described with respect to one embodiment may be present in any of the other described embodiments. In addition, other features and advantages of the present disclosure will become apparent to those of ordinary skill in the art through consideration of the following detailed description and the accompanying drawings.

### BRIEF DESCRIPTION OF THE DRAWINGS

A more particular description of the invention briefly described above will be rendered by reference to specific embodiments as illustrated in the appended drawings. Understanding that these drawings depict only typical embodiments of the invention and are therefore not to be considered limiting of its scope, the invention will be described and explained with additional specificity and detail through the use of the accompanying drawings.

FIG. 1 charts apparent viscosity (ETA) of starch-based NuPlastiQ materials as described herein but without any additives, tested by Goettfert RG 25 capillary rheometer at 180° C., with a 30 L/D 1 mm die showing the effect of molecular weight of the starting starch material on apparent viscosity of the resulting starch-based material.

FIG. 2 charts apparent viscosity of starch-based NuPlastiQ materials as described herein, formed with reduced plasticizer content, and/or with additives, as measured by Goettfert RG 25 capillary rheometer at 180° C., using a 30 L/D 1 mm die. The results show significantly reduced viscosity for the resulting starch-based material formed with a high molecular weight starch starting material by adding DL-malic acid (“DLMA”).

FIG. 3 charts dart drop impact strength for biopolymer films formed by blending PBAT with starch-based polymeric materials such as those shown in FIG. 2, showing how dart drop impact strength is increased by using higher molecular weight native starch as a starting material, with addition of DLMA, as compared to using a lower molecular weight starch as a starting material, without addition of DLMA.

FIG. 4 shows machine direction tear strength characteristics for similar biopolymer films shown in FIG. 3, showing how machine direction (“MD”) tear strength is increased, by using a higher molecular weight starch with DLMA addition, as compared to use of a lower molecular weight starch, without DLMA addition.

FIG. 5 shows transverse direction tear strength characteristics for similar biopolymer films as shown in FIG. 4, showing how transverse direction (“TD”) tear strength is increased, by using a higher molecular weight starch with DLMA addition, as compared to use of a lower molecular weight starch, without DLMA addition.

FIG. 6 shows MD tensile strength and MD tensile elongation characteristics for similar biopolymer films as shown in FIG. 4, showing how MD tensile strength and MD tensile elongation are increased, by using a higher molecular weight starch with DLMA addition, as compared to use of a lower molecular weight starch, without DLMA addition. The tested films had a thickness of about 1 mil.

FIG. 7 shows TD tensile strength and TD tensile elongation characteristics for similar biopolymer films as shown in FIG. 6, showing how TD tensile strength and TD tensile elongation are increased, by using a higher molecular weight starch with DLMA addition, as compared to use of a lower molecular weight starch, without DLMA addition. The tested films had a thickness of about 1 mil.

FIG. 8 illustrates various exemplary glyceride structures that may be added to the present starch-based polymeric materials, for increased hydrophobicity and other characteristics.

FIG. 9 charts moisture mass gain over time for pellets of an exemplary NuPlastiQ starch-based material as compared to similar NuPlastiQ starch-based materials as described herein, which included different levels of triglyceride oil additive. Testing was performed at 93% relative humidity and 38° C.

FIG. 10 charts moisture mass gain over time for pellets of an exemplary NuPlastiQ starch-based material as compared to similar NuPlastiQ starch-based materials as described herein, which included various fatty acid and/or acid anhydride additives. Testing was performed at 93% relative humidity and 38° C.

FIG. 11 is a plot comparing glycerin stability for formulations with and without a silicone component, measured using a 30 L/D, 1 mm die, at 190° C. with an apparent shear rate (ETA) of 200 1/s.

### DETAILED DESCRIPTION

### I. Definitions

All publications, patents and patent applications cited herein, whether supra or infra, are hereby incorporated by reference in their entirety to the same extent as if each individual publication, patent or patent application was specifically and individually indicated to be incorporated by reference. Such incorporation by reference includes the prosecution history of Applicant's earlier patents, many of which have been issued.

The term “comprising” which is synonymous with “including,” “containing,” or “characterized by,” is inclusive or open-ended and does not exclude additional, unrecited elements or method steps.

The term “consisting essentially of” limits the scope of a claim to the specified materials or steps “and those that do not materially affect the basic and novel characteristic(s)” of the claimed invention.

The term “consisting of” as used herein, excludes any element, step, or ingredient not specified in the claim.

The terms “a,” “an,” “the” and similar referents used in the context of describing the inventive features (especially in the context of the following claims) are to be construed to cover both the singular and the plural, unless otherwise indicated herein or clearly contradicted by context. Thus, for example, reference to a “starch” can include one, two or more starches.

Unless otherwise stated, all percentages, ratios, parts, and amounts used and described herein are by weight, including molecular weights—i.e., weight average molecular weights, vs. number average molecular weights. Unless otherwise stated, all percentages, ratios, parts, and amounts used and described herein are exclusive of water content.

All numerical quantities in this description indicating amounts of material or conditions of reaction and/or use are to be understood as modified by the word “about” in describing the broadest scope of the disclosure. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements. By way of example, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition.

Some ranges are disclosed herein. Additional ranges may be defined between any values disclosed herein as being exemplary of a particular parameter. All such ranges are contemplated and within the scope of the present disclosure. Further, recitation of ranges of values herein is intended to serve as a shorthand method of referring individually to each separate value falling within the range. Unless otherwise indicated herein, each individual value is incorporated into the specification as if it were individually recited herein.

The phrase ‘free of’ or similar phrases as used herein means that the composition comprises 0% of the stated component, that is, the component has not been intentionally added to the composition. However, it will be appreciated that such components may incidentally form under appropriate circumstances, may be incidentally present within another included component, e.g., as an incidental contaminant, or the like.

The phrase ‘substantially free of’ or similar phrases as used herein means that the composition preferably comprises 0% of the stated component, although it will be appreciated that very small concentrations may possibly be present, e.g., through incidental formation, incidental contamination, or even by intentional addition. Such components may be present, if at all, in amounts of less than 1%, less than 0.5%, less than 0.25%, less than 0.1%, less than 0.05%, less than 0.01%, less than 0.005%, or less than 0.001%.

The term “non-biodegradable” as used herein with regard to a material means that the native material (free of additives added to render it biodegradable) does not degrade (particularly biodegrade), e.g., to carbon dioxide and/or methane to a significant extent in a reasonable limited time period (e.g. one year, 2 years, 3 years, or 5 years) when exposed to various typical disposal conditions, such as sunlight, in the ocean, in a landfill, industrial or other compost conditions, or to specific ASTM conditions intended to evaluate biodegradability (e.g., ASTM D-5511, D-5526, D-5338, D-6691). However, it is understood that given enough time and exposure to conditions of sunlight, oxygen and degrading microbes, most polymeric materials (e.g., even those that are typically considered “non-biodegradable”) will eventually degrade or even biodegrade, usually to some limited extent, over an extended time (e.g., centuries).

The term “biodegradable” as used herein with regard to a material means that the material as described herein does significantly biodegrade (e.g., over 20%, over 30%, over 40%, or over 50%) to base molecules such as carbon dioxide, methane and/or water by the action of appropriate microorganisms, within a reasonable limited time frame (e.g., 5 years, 3 years, 2, years, 1 year, etc.) under “ideal” biodegradation conditions (e.g., anaerobic digester, industrial compost, or the like), e.g., such as conditions under various ASTM biodegradability tests (e.g., ASTM D-5511, D-5338, D-6691).

The term “modified” as used, e.g., in describing “modified starch” and the like, refers to physical and/or chemical modifications, including the conversion of a starting starch material to one that includes a lower molecular weight. Applicant's NuPlastiQ material may be considered to comprise a “modified” starch. Starches that may not necessarily fall within the description of the term “modified”, may also be suitable, e.g., particularly for use in forming a modified starch such as NuPlastiQ.

The descriptions herein are merely exemplary, and it will be appreciated that numerous modifications or variations to such starch components are possible. Applicant's NuPlastiQ materials as described herein are examples of a modified starch-based material, having very high molecular weight, available from Applicant. Determination of molecular weight may be through any desired process, e.g., any of various size exclusion chromatography techniques (e.g., gel permeation chromatography (“GPC”) or gel filtration chromatography (“GFC”).

The terms “film” and “sheet” as used herein refer to articles that are generally 2-dimensional, with a thickness that is significantly less than the length and/or width of the article, as will be familiar to those of skill in the art. Such articles may include one or more layers. By way of example, a film or any individual layers thereof can have a thickness of at least 0.001 mm, at least 0.002 mm, at least 0.004 mm, at least 0.01 mm, at least 0.02 mm, at least 0.03 mm, at least 0.05 mm, at least 0.07 mm, at least 0.10 mm, no greater than 2 mm, no greater than 1 mm, no greater than 0.5 mm, no greater than 0.1 mm, from about 0.05 mm to about 0.5 mm, or from 0.02 mm to 0.05 mm. While there may be some overlap in thickness values for film and sheet articles, it will be appreciated that sheet materials are generally thicker than a film, e.g., having a thickness of up to 10 mm, or perhaps more.

In reference to various standardized tests (e.g., ASTM or other tests), it will be understood that reference to any such standard refers to the latest update (if any) of such standard, unless otherwise indicated. Any such referenced standards are incorporated herein by reference, in their entirety.

### II. Exemplary Embodiments

Applicant has found that changing the amount of plasticizer is one “lever” that can be used to modify the rheological properties of the resulting thermoplastic starch, as shown below in Table 1. Table 1 compares the apparent shear viscosity of conventional NuPlastiQ with a similar starch-based material, but formulated with less plasticizer. Plasticizer amounts were reduced from 25-30% (e.g., 27%) plasticizer to 20-25% (e.g., 23%) plasticizer.

TABLE 1

| | ETA20 1/s | ETA200 1/s | ETA1000 1/s |
|---|---|---|---|
| Material | [Pa · s] | [Pa · s] | [Pa · s] |
| Conventional NuPlastiQ | 3717.8 | 1036.8 | 433.9 |
| NuPlastiQ with Reduced | 4217.8 | 1414.1 | 607.7 |
| Plasticizer Amount | | | |

Measured with a 30 L/D, 1 mm die at 180° C.

As shown in Table 1, by reducing the plasticizer amount, viscosity increases. Conversely, increasing the amount of plasticizer can decrease viscosity, making the material more suitable for nonwoven spinning type applications in some respects, although this presents challenges in other respects. For example, while including more plasticizer improves the rheological properties, under high shear fiber forming and spinning processes, this additional plasticizer volatilizes, blooms to the surface (e.g., phase separation), generates smoke during processing (particularly where the plasticizer includes glycerin), interrupts spinning and results in low-quality fibers (e.g., problems with low strength, etc.)

One aspect of the present invention describes simple additive approaches to mitigate issues associated with the reduction in plasticizer content as well as mechanical and chemical processes that convert starches to thermoplastic starches, with favorable rheological properties. These processes also make the resulting thermoplastic starch more processable under typical nonwoven processing conditions (i.e., they reduce apparent viscosity). In particular, one aspect of the present disclosure contemplates the addition of a diacid, a corresponding acid anhydride, or other additives in small amounts, during manufacture of the NuPlastiQ thermoplastic starch-based polymeric material itself (e.g., not addition of such additives when also adding a partner resin, such as a polyolefin, polyester, polystyrene, a polyamide, etc., but addition when converting the starch into a thermoplastic starch). In an embodiment, the starch may be the only, or substantially the only polymer present when such diacids, acid anhydrides, or other additives are added. Contemplated diacids, acid anhydrides and other additives can reduce migration of glycerin, sorbitol or other plasticizers within the starch-based polymeric material (particularly migration during processing associated with formation of nonwovens), and can otherwise improve processability of the resulting starch-based polymeric material.

In particular, the addition of a diacid or corresponding acid anhydride during formation of the thermoplastic starch-based polymeric material allows reduction in the amount of plasticizer required, while maintaining or even improving other properties (e.g., apparent viscosity).

Table 2 below shows the effect of various additives on the apparent shear viscosity of the starch-based polymeric materials (e.g., NuPlastiQ) formed according to the present invention. Such results were measured by capillary rheometer using a 30 L/D, 1 mm die at 180° C. The examples in Table 2 and elsewhere herein described as formed with reduced or “low” plasticizer included 20-25% plasticizer (e.g., 23% glycerin). Examples described as including “lowest” plasticizer included 21% plasticizer (e.g., 21% glycerin). Those examples described as using a standard, normal, or “not modified” amount of plasticizer included 25-30% plasticizer (e.g., 27% glycerin).

TABLE 2

| | | ETA20 | ETA200 | ETA 1000 |
|---|---|---|---|---|
| Glycerin | | 1/s | 1/s | 1/s |
| Level | Description | [Pa · s] | [Pa · s] | [Pa · s] |
| Not modified | NPQ 1 | 3718 | 1037 | 434 |
| Not modified | NPQ 1 w/1% maleic anhydride | 369 | 74 | 26 |
| Lowest | NPQ 1 w/0.2% malic acid | 1282 | 392 | 184 |
| Not modified | NPQ 2 | 7130 | 2192 | 885 |
| Not modified | NPQ 2 w/0.1% maleic anhydride | 2120 | 612 | 278 |
| Not modified | NPQ 2 w/0.2% maleic anhydride | 1451 | 390 | 181 |
| Not modified | NPQ 2 w/0.3% maleic anhydride | 1166 | 267 | 124 |
| Not modified | NPQ 2 w/0.5% maleic anhydride | 437 | 93 | 40 |
| Not modified | NPQ 2 w/0.5% maleic anhydride and | 1468 | 257 | 81 |
| | 0.5% stearic acid | | | |
| Not modified | NPQ 2 w/0.3% malic acid | 952 | 190 | |
| Low | NPQ 2 w/0.3% malic acid | 847 | 139 | 54 |
| Low | NPQ 2 w/0.3% malic acid and 0.3% | 1148 | 328 | 148 |
| | glycidyl ether | | | |
| Low | NPQ 2 w/0.3% malic acid and 0.4% | 822 | 208 | |
| | glycidyl ether | | | |
| Not modified | NPQ 3 | 3938 | 1012 | 411 |
| Low | NPQ 3 w/0.3% DL malic acid | 1300 | 326 | 152 |
| Low | NPQ 3 w/0.3% DL malic acid and | 2049 | 464 | 208 |
| | 0.3% glycidyl ether | | | |

Table 3 below shows rheological properties of nonwoven grade polypropylenes, as compared to a previous NuPlastiQ formulation that is suitable for nonwovens (e.g., as described in applicant's U.S. application Ser. No. 17/327,536 (21132.31.1), U.S. application Ser. No. 17/327,577 (21132.31.2), and U.S. application Ser. No. 17/327,590 (21132.31.3). Measurements were made by capillary rheometer using a 30 L/D, 1 mm die at the temperatures noted.

TABLE 3

| | | ETA20 | ETA200 | ETA 1000 |
|---|---|---|---|---|
| | Test | 1/s | 1/s | 1/s |
| Material | Temp. | [Pa · s] | [Pa · s] | [Pa · s] |
| 35 MFI spun grade PP | 230° C. | 233 | 136 | 64 |
| 35 MFI spun grade PP | 190° C. | 636 | 263 | 98 |
| Meltblown grade PP | 190° C. | 45 | 49 | 33 |
| Formulation with 50% NPQ | 190° C. | 1111 | 306 | 112 |
| Formulation with 25% NPQ | 190° C. | 203 | 126 | 60 |

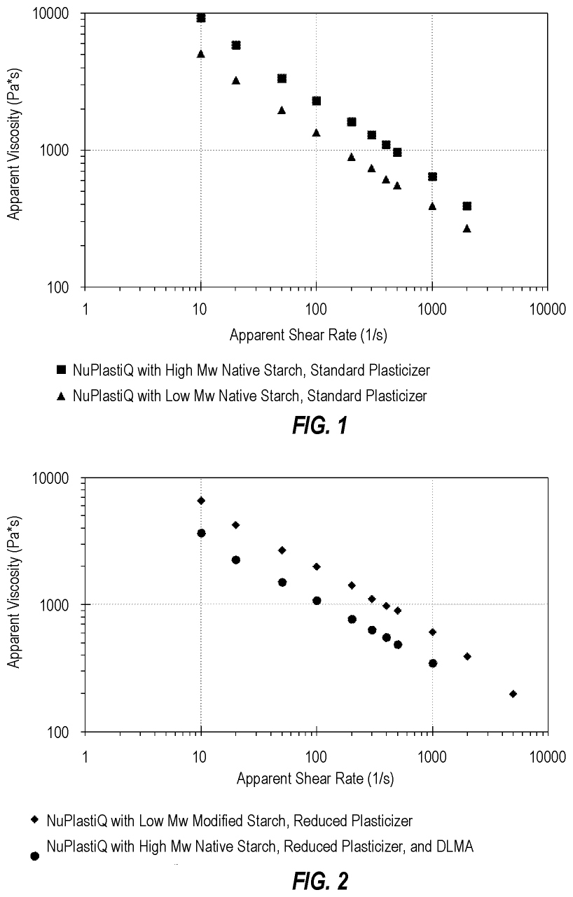

FIG. 1 shows how the molecular weight of the starch-based polymeric material (e.g., NuPlastiQ) can affect the apparent viscosity of the starch-based material. The values shown in FIG. 1 were obtained using a Goettfert RG 25 capillary rheometer at 180° C., with a 30 L/D, 1 mm die. In FIG. 1, the data points labeled “NuPlastiQ with High Mw Native Starch” are for a NuPlastiQ starch-based material formed from a high molecular weight native corn starch and a plasticizer (e.g., glycerin) having a molecular weight as referenced in Table 4. Each of the prepared starch-based polymeric materials of FIG. 1 do not include any additives, as described herein, but are provided for purposes of showing the effect of the molecular weight of the starting starch material. In other words, they are simply prepared from just the particular high and low molecular weight corn starches and plasticizer (not including any water that may be present). The data points labeled “NuPlastiQ with Low Mw Modified Starch” are for a NuPlastiQ starch-based material formed from lower molecular weight modified corn starch and a plasticizer (e.g., glycerin) having a molecular weight as referenced in Table 4.

Table 4 reports the molecular weight characteristics for the starting starches used to form the NuPlastiQ materials, as well as the molecular weight characteristics of such finished NuPlastiQ materials. It is interesting to note that the NuPlastiQ reactive extrusion process results in increased molecular weight for the finished product formed from the modified low Mw corn starch, while providing decreased molecular weight for the finished product formed from the native high Mw corn starch, as compared to the molecular weight of the starting starch materials. For example, whether the starting starch has a weight average molecular weight (Mw) of around 10-15 million or 65 to 70 million, the resulting NuPlastiQ material exhibits a middleground weight average molecular weight of around 20 to 40 million. Such relatively high molecular weight values are not typical of most thermoplastic starch materials. In any case, it will be apparent that differing molecular weights can be achieved by employing starches of differing molecular weights as raw materials from which the NuPlastiQ starch-based polymeric material is formed. It will also be apparent that not all starches sourced from a particular plant are identical, but may differ widely in molecular weight, and other characteristics. For example, not all corn starches are equivalent to one another, nor are all potato starches equivalent to one another, and so forth. Table 4 reports number average molecular weights (Mn), weight average molecular weights (Mw) and z-average molecular weights (Mz). Those of skill in the art will appreciate that z-average molecular weights emphasize large molecules even more than does Mw.

TABLE 4

| Sample Description | Mn | Mw | Mz |
|---|---|---|---|
| Low Mw Modified Corn Starch | 3,010,000 | 11,700,000 | 93,800,000 |
| High Mw Native Corn Starch | 48,700,000 | 67,300,000 | 136,000,000 |
| High Mw Native Potato Starch | 41,700,000 | 45,300,000 | 50,900,000 |
| NuPlastiQ formed from Low Mw Modified Corn | 14,200,000 | 26,400,000 | 192,000,000 |
| Starch | | | |
| NuPlastiQ formed from High Mw Native Corn | 25,000,000 | 35,600,000 | 135,000,000 |
| Starch | | | |
| NuPlastiQ formed from Low Mw Modified Corn | 85,500 | 173,000 | 546,000 |
| Starch with 1% MAH (maleic anhydride) | | | |
| NuPlastiQ formed from High Mw Native Corn and | 155,000 | 473,000 | 1,570,000 |
| Potato Starch with 0.5% MAH | | | |

In addition to the starch and plasticizer, each example as initially mixed also included 10-25%, 10-20%, or 15-25% water, besides any additional additives as described herein that may be included. As described, during manufacture of the starch-based material, typically no polymeric materials, other than the starch itself, are present (e.g., no polyolefins or other polymer resins, which are only ever added after the starch-based material has been formed, as a blend incorporating the starch-based material). Essentially all water initially present during manufacture is removed during the reactive extrusion process, so that the finished NuPlastiQ starch-based material includes less than 1% water. As such, the percentages as noted herein (e.g., percentages of starch and plasticizer) are typically on a “dry” basis, exclusive of the initial water that may be present in the initial mixture fed into the extruder or other system.

As shown in FIG. 2, by adding a small amount (e.g., 0.5%) of a diacid, such as DL-malic acid (e.g., a racemic mixture including both D and L enantiomers), the apparent viscosity of the NuPlastiQ starch-based material formed with native high molecular weight starches can be reduced to below that of a similar NuPlastiQ starch-based product, formed without the diacid, formed from a lower molecular weight starch. In preparing the various examples, a combination of starches or a single starch, (e.g., one or more of corn, potato, tapioca, cassava, etc.), was combined with the plasticizer (e.g., one or more of glycerin, sorbitol, maltitol, or propane diol, etc.), water, and any additives (e.g., an organic diacid) as described herein.

Typical fractions included 20-25% plasticizer, 10-25%, 10-20% or 15-25% water, and 0.01-5%, or 0.1-5.0% of the diacid, with the balance being the one or more starches. In more detail, the starch-based material can be formed from mostly starch. For example, at least 50%, at least 55%, at least 60%, at least 65%, at least 70%, at least 75%, or at least 80%, no more than 85%, or no more than 80% such as from 50-85%, from 65-85% or from 65% to 90% by weight of the starch-based material may be attributable to the one or more starches. Other than negligible water content (e.g., no more than 2%, or no more than 1%), nearly the balance of the finished starch-based material may be or attributed to the plasticizer (e.g., sorbitol, glycerin, etc.), other than the diacids, acid anhydrides, or other additives as described herein. Non-limiting examples of suitable starches include one or more of corn starch, tapioca starch, cassava starch, wheat starch, potato starch, rice starch, sorghum starch, algae starch, etc. It will be apparent that a variety of starches may be used. In an embodiment, the starting starch may have a relatively high molecular weight, e.g., a weight average molecular weight of at least 1 million, 2 million, 3 million, 4 million, 5 million, 10 million, 15 million, 20 million, 25 million, 30 million, 35 million, 40 million, 45 million or 50 million. By way of example, the starting starch material may have a weight average molecular weight Mw of from 10 million to 100 million, or from 20 million to 80 million, or from 30 million to 80 million, or from 40 million to 80 million, or from 50 million to 80 million, or from 60 million to 80 million. By way of example, the finished starch-based polymeric material may have a weight average molecular weight Mw of from 0.1 million to 100 million, from 0.2 million to 50 million, from 0.3 million to 50 million, from 0.3 million to 30 million, from 0.3 million to 20 million. The lower molecular weight values in such ranges may be particularly associated with addition of the diacid or acid anhydride additives, as described herein. Mw to Mn ratios (polydispersity) for the starting starch, or the finished starch-based polymeric material may be greater than 1, such as from 1 to 2, 1 to 3, or 1 to 4.

By way of example, materials from which the starch-based material is formed can include at least 12%, at least 15%, at least 18%, at least 20%, at least 22%, no greater than 35%, no greater than 32%, no greater than 30%, no greater than 28%, or no greater than 25% (e.g., 20-25%) by weight of a plasticizer. Exemplary plasticizers include, but are not limited to glycerin, sorbitol, maltitol, or propane diol, polyethylene glycol, polyhydric alcohol plasticizers, hydrogen bond forming organic compounds which do not have a hydroxyl group, anhydrides of sugar alcohols, animal proteins, vegetable proteins, aliphatic acids, phthalate esters, dimethyl and diethylsuccinate and related esters, glycerol triacetate, glycerol mono and diacetates, glycerol mono, di, and tripropionates, butanoates, stearates, lactic acid esters, citric acid esters, adipic acid esters, stearic acid esters, oleic acid esters, other acid esters. Combinations of different plasticizers may be used. In an embodiment, sorbitol may be used. In an embodiment, the plasticizer may not include glycerin.

In the preparation of the “New” NuPlastiQ thermoplastic starch-based materials as described herein, one could use native starches, modified starches, or combinations thereof. Selection of plasticizer and starch raw materials, as well as the additives from which to form any given batch of NuPlastiQ may depend on intended use, e.g., use as a film, for use in nonwoven fiber production, as well as the particular article property improvements desired, etc.

The finished starch-based material may include no greater than 5%, no greater than 4%, no greater than 3%, no greater than 2%, no greater than 1.5%, no greater than 1%, or no greater than 0.8% by weight water, including any bound water.

Table 5 shows the rheological effect of the addition of various diacid or acid anhydride additives during reactive extrusion manufacture of the present starch-based materials, as measured by Goettfert RG 25 capillary rheometer using a 30 L/D, 1 mm die at 180° C.

TABLE 5

| | | | | ETA | ETA | ETA | ETA | ETA |
|---|---|---|---|---|---|---|---|---|
| | | Plasticizer | | 20 1/s | 100 1/s | 200 1/s | 500 1/s | 1000 1/s |
| Ex. | Starch | Amount | Additive | [Pa * s] | [Pa * s] | [Pa * s] | [Pa * s] | [Pa * s] |
| 1 | Corn/Potato | Standard | MAH | 1166 | 385 | 267 | 170 | 124 |
| | mixture | | 0.3% | | | | | |
| 2 | Corn/Potato | Standard | Maleic | 952 | 272 | 190 | 170 | 124 |
| | mixture | | Acid, | | | | | |
| | | | 0.3% | | | | | |
| 3 | Corn/Potato | Standard | Succinic | 3335 | 1307 | 918 | 547 | 391 |
| | mixture | | Acid, | | | | | |
| | | | 0.3% | | | | | |
| 4 | Corn/Potato | Standard | Malic | 1182 | 451 | 317 | 184 | 130 |
| | mixture | | Acid, | | | | | |
| | | | 0.3% | | | | | |
| 5 | Corn/Potato | Reduced | Malic | 1132 | 450 | 326 | 204 | 155 |
| | mixture | | Acid, | | | | | |
| | | | 0.3% | | | | | |

In an embodiment, a variety of alkyl and/or alkenyl diacids such as maleic acid, fumaric acid, tartaric acid, malic acid, succinic acid or others, or anhydrides thereof, could be used in combination with the one or more different starch materials, along with one or more suitable plasticizers. In an embodiment, the diacid or corresponding acid anhydride additive may be included in only a small amount, such as less than 5%, less than 4%, less than 3%, less than 2%, less than 1%, or less than 0.5%, greater than 0.01%, greater than 0.05%, greater than 0.1%, greater than 0.2%, greater than 0.3%, or greater than 0.4%, such as from 0.01% to 5%, from 0.1% to 5%, from 0.2% to 3%, from 0.2% to 1%, from 0.2% to 0.4%, or from 0.2% to 0.3% by weight of the components. As shown in Table 4, even a 1% addition (or 0.5% addition) of such an additive can result in a very significant decrease in molecular weight. Table 5 shows how such small additions of a diacid or acid anhydride can significantly reduce the viscosity characteristics of the resulting starch-based material. The mixture of starch(es), plasticizer(s), water and additives is gelatinized/processed/reacted in an extruder or similar system to produce a reactive extrusion product that is a highly amorphous thermoplastic starch having characteristics that may be characteristic to NuPlastiQ starch-based material, described in applicant's previous applications, already incorporated by reference. Such characteristics can differ significantly from conventional thermoplastic starch materials, as described in applicant's previous applications. Various reactive extruder or similar systems may be employed, e.g., as described herein, as described in applicant's earlier applications, in U.S. Pat. No. 10,857,697 (herein incorporated by reference in its entirety), or various other possible extruder or compounding systems.

A summary of such characteristics includes low crystallinity, resistance to recrystallization, and a lack of sea-island features when blended with a partner resin. For example, in an embodiment, the starch-based material may be substantially amorphous. For example, raw starch powder typically has an approximately 50% crystalline structure. Many thermoplastic starch materials similarly have relatively high crystallinity. By way of example, the starch-based material used as described herein may have a crystallinity of less than about 40%, less than about 35%, less than about 30%, less than about 25%, less than about 20%, less than about 15%, less than about 10%, less than 9%, less than about 8%, less than 7%, less than about 6%, less than about 5%, or less than about 3%. Any suitable test mechanism for determining crystallinity may be used, e.g., including but not limited to FTIR analysis, X-ray diffraction methods, and symmetrical reflection and transmission techniques. Various suitable test methods will be apparent to those of skill in the art.

Low water content is not achieved in the NuPlastiQ material through esterification or etherification, as is common in some other TPS materials that may include relatively low water content. Such esterification or similar modifications can be expensive and complex to perform. Furthermore, the NuPlastiQ materials that are exemplary of the starch-based materials employable herein have been mechanically, physically or chemically reacted and/or altered, compared to the starting starch and plasticizer materials. For example, the starch-based material is the product of a reactive extrusion process, e.g., under pressure, at extrusion temperatures of at least 85° C., at least 90° C., at least 95° C., at least 100° C., at least 120° C., at least 130° C., at least 140° C., at least 150° C., at least 155° C., at least 160° C., at least 165° C., at least 170° C., at least 175° C., at least 180° C., at least 185° C., no greater than 250° C., no greater than 230° C., no greater than 225° C., no greater than 220° C., no greater than 210° C., no greater than 205° C., no greater than 200° C., no greater than 195° C., such as from 130° C. to 250° C., from 85° C. to 165° C., from 180° C. to 210° C., from 185° C. to 205° C., or from 185° C. to 200° C. (e.g., 190° C. or 195° C.). The mixture of the starch(es), the plasticizer(s), water, and any additives is thoroughly mixed (e.g., in an orbital mixer or similar system). This mixture is fed into the extruder, where it is exposed to shear and temperatures as noted. During the reactive extrusion process, excess plasticizer and moisture/water are removed by vacuum suction, resulting in a thermoplastic starch in molten form, which is cut into pellet form by a strand cutter. The finished starch-based material may not be recognized as a simple mixture including native starch and plasticizer, but has undergone chemical and/or physical changes, including changes in molecular weight relative to the starting starch material.

The low water content achievable in the starch-based material may be due at least in part to the physical or chemical alteration of the starch and plasticizer materials into a starch-based thermoplastic polymer, which does not retain water to the same degree as may be the case with native starch, or other conventional thermoplastic starch materials. In addition, the NuPlastiQ materials resist recrystallization or retrogradation, common with many other thermoplastic starches. For normal thermoplastic starches, they exhibit a tendency to “retrograde” which is exhibited as they recrystallize over time from a relatively amorphous state back into a more crystalline state—the natural state of native starch powder. Most thermoplastic starches recrystallize over time because the thermoplastic starch structure is not sufficiently stabilized to limit the mobility of starch molecules, plasticizer migration and evaporation over time. In contrast, NuPlastiQ does not retrograde or recrystallize to any significant degree. While some starch-based polymeric materials are enzymatically debranched (e.g., increasing the amylose fraction, decreasing the amylopectin fraction), decreasing the molecular weight thereof, the presently described starch-based polymeric materials do not require such enzymatic treatment for debranching, or for other purposes. As noted, exemplary starch-based materials can exhibit decreased (or increased) molecular weight as compared to the starting starch material, and/or increased amylose content.

Table 6 below shows the effect on viscosity/rheology for inclusion of varying amounts of a diacid or anhydride additive (e.g., maleic anhydride, maleic acid, etc.) on exemplary starch-based polymeric materials, as measured by Goettfert RG 25 capillary rheometer using a 30 L/D, 1 mm die at 180° C.

TABLE 6

| | | | | ETA | ETA | ETA | ETA | ETA |
|---|---|---|---|---|---|---|---|---|
| | | Plasticizer | Additive | 20 1/s | 100 1/s | 200 1/s | 500 1/s | 1000 1/s |
| Ex. | Starch | Amount | Fraction | [Pa * s] | [Pa * s] | [Pa * s] | [Pa * s] | [Pa * s] |
| 1 | Corn/Potato | Standard | 0.1% | 2120 | 858 | 612 | 383 | 278 |
| 2 | Corn/Potato | Standard | 0.2% | 1451 | 572 | 390 | 246 | 181 |
| 3 | Corn/Potato | Standard | 0.3% | 1166 | 385 | 267 | 170 | 124 |
| 4 | Corn/Potato | Standard | 0.4% | 369 | 118 | 75 | 44 | 29 |
| 5 | Corn | Standard | 0% | 3430 | 1371 | 954 | 600 | 418 |
| 6 | Corn | Standard | 1% | 369 | 109 | 74 | 43 | 26 |

Several non-limiting exemplary diacid structures, or anhydrides thereof which may be suitable for use as additives as described herein, are shown below.

Fumaric acid has the following structure.

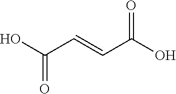

Succinic acid and succinic anhydride have the following respective structures.

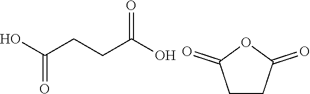

Maleic anhydride has the following structure.

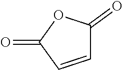

Maleic acid has the following structure.

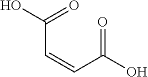

Malic acid has the following structure.

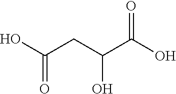

Tartaric acid has the following structure.

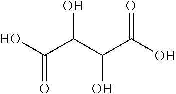

An additional example of a diacid that may be used may have the following structure.

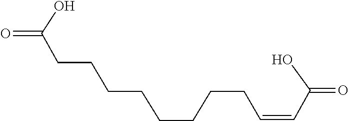 [SMILES: O=C(O)/C=C\CCCCCCCCC(=O)O]

Various other diacids or anhydrides thereof will be apparent to those of skill in the art, any of which may also be suitable for use. Inclusion of such a diacid or acid anhydride makes it possible to use less glycerin, sorbitol or other plasticizer, while still producing thermoplastic starches exhibiting favorable rheological properties, e.g., suitable for spinning, for manufacture of nonwovens. Thus, in an embodiment, it is the combination of the reduced plasticizer content (e.g., 20-25% plasticizer) coupled with the inclusion of the small amount of the diacid or corresponding anhydride that is important. Such a combination may provide the resulting starch-based material with an apparent viscosity (ETA) at 200 1/s that is less than 500 Pa·s, less than 300 Pa·s, or less than 200 Pa·s, such as from 30 Pa·s to 500 Pa·s, or from 50 Pa·s to 300 Pa·s, or from 100 Pa·s to 200 Pa·s, and/or an apparent viscosity (ETA) at 1000 1/s that is less than 400 Pa·s, less than 300 Pa·s, less than 200, or less than 150 Pa·s, such as from 15 Pa·s to 300 Pa·s, or from 30 Pa·s to 200 Pa·s, or from 50 Pa·s to 130 Pa·s. Such characteristics provide the increased strength and other properties noted herein, while also providing desired rheology characteristics, that permit use of such starch-based materials in spinning applications.

In an embodiment, any of a variety of alkyl monoacids can be used in combination with a diacid, e.g., to enhance the hydrophobic properties of the resulting starch-based material. An example of such an alkyl fatty acid is shown below. Numerous others will be apparent to one of skill in the art. The alkyl chain length may affect the degree of increased hydrophobicity of the resulting starch-based material. For example, exemplary alkyl chain lengths may range from greater than 6, greater than 8, greater than 10, or greater than 12 carbon atoms in length (e.g., 6-30, 6-20, 8-20, 12-30, 12-20, or 12-18 carbons).

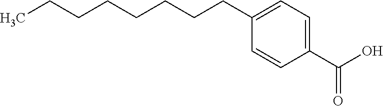 [SMILES: CCCCCCCCc1ccc(C(=O)O)cc1]

The produced thermoplastic starch may be combined with other polymers, particularly polyester biopolymers such as poly lactic acids (PLA); poly butylene adipate terephthalate (PBAT); polybutylene succinate (PBS); poly hydroxy alkanoates (PHAs); other polyesters, as well as more conventional fossil-fuel-based polymers, such as polyethylene (PE), polypropylene (PP) polystyrene (PS), polyamides, etc. Such listing is not exhaustive, and the produced thermoplastic starch may be blended with numerous other polymers, as well. The NuPlastiQ starch-based material including the diacid, corresponding anhydride, or other additives can be blended with such other polymers in an amount of at least 0.5%, at least 1%, at least 2%, at least 3%, at least 4%, at least 5%, at least 10%, at least 15%, at least 20%, no greater than 99%, no greater than 95%, no greater than 90%, no greater than 80%, no greater than 70%, no greater than 60%, no greater than 50%, no greater than 40%, from 5% to 80%, from 5% to 60%, from 5% to 50%, from 5% to 40% from 2% to 60%, from 10% to 40%, from 20% to 35%, or from 20% to 30%, by weight of the blend. Other ranges defined between any end point values taken from the above or elsewhere from the present disclosure are also contemplated. The resulting blend can be used for making nonwovens and melt spun fibers used in nonwovens, with good mechanical properties. In an embodiment, the partner resin may be present in an amount calculated from any of the above fractions, by subtracting 100% therefrom, e.g., in a range of from 1% to 99.5%, from 5% to 80%, no greater than 99.5%, no greater than 99%, no greater than 98%, no greater than 97%, no greater than 96%, no greater than 95%, no greater than 90%, no greater than 85%, no greater than 80%, at least 1%, at least 5%, at least 10%, at least 20%, at least 30%, at least 40%, at least 50%, at least 60%, from 20% to 95%, from 40% to 95%, from 50% to 95%, from 60% to 95% from 40% to 98%, from 60% to 90%, from 65% to 80%, or from 70% to 80%, by weight of the blend. Other ranges defined between any end point values taken from the above or elsewhere from the present disclosure are also contemplated.

The addition of the diacid during manufacture of the thermoplastic starch, with the sorbitol, glycerin or other plasticizer can aid in reducing migration of such plasticizers within the NuPlastiQ starch-based polymeric material, which can be particularly important when processing such formulations to manufacture nonwovens, as there is less tendency for the plasticizer to separate and bloom to the surface, generate smoke during nonwoven manufacture, interrupt spinning (requiring shut down), or reduce strength in the resulting fibers. Such reduction is also beneficial when blended with polyester biopolymer materials, such as those noted above. For example, this can significantly improve the shelf-life of such polymer blends, e.g., in PBAT, PLA and other polyester blends, where hydrolyzable groups of such polyesters can otherwise be attacked by the glycerin or other plasticizer present in the starch-based polymeric material.

It is important that the diacid, corresponding anhydride, or other additive addition as described herein occur during manufacture of the thermoplastic starch (e.g., during formation of the reactive extrusion product), before the other polymer material with which the starch-based polymeric material may eventually be blended, is present. In particular, the desired reaction with the diacid or corresponding anhydride occurs quickly within the extruder or similar system where the thermoplastic starch is formed, while such desired reaction does not reliably occur within any reasonable time frame, absent such conditions of elevated temperature, pressure, shear, etc. within the extruder or similar system. In addition, the absence of the other polymeric material (e.g., polyolefin, polyester, polyamide, polystyrene, etc.) during such reaction is helpful to ensure concentration of the desired reaction materials (i.e., starch and plasticizer, relative to the diacid or acid anhydride).

In an embodiment, one or more fatty acid additives, (e.g., triglycerides, and/or monoglycerides and/or diglycerides including a fatty acid residue) can be included, when forming the starch-based polymeric material. Such fatty acid additives may be included apart from any diacid or acid anhydride, or in combination with such. By way of example, the fatty acid glycerides may be included in an amount from 1% to 30%, 1% to 10%, 5% to 25%, or 10% to 20% by weight of the components. Exemplary amounts may include 1%, 2%, 3%, 4%, 5%, 6%, 7%, 8%, 9%, 10%, 11%, 12%, 13%, 14%, 15%, 16%, 17%, 18%, 19%, 20%, 21%, 22% 23%, 24%, 25%, 26%, 27%, 28%, 29%, or 30% by weight of the components. Additional exemplary ranges may be defined between any of the above endpoints. As described above relative to the diacid and acid anhydride embodiments, the starch or starches may typically be present in an amount of from 50-85%, or from 65% to 85% by weight of the components, and the glycerin or other plasticizer may typically be present in an amount of from 10% to 30%, or from 15% to 30% by weight of the components. Such values may be on a dry basis, absent any water that may be present, either initially, or in the final product. This mixture is gelatinized/processed in an extruder or similar system to create highly amorphous thermoplastic starch having characteristics of NuPlastiQ, described in applicant's previous applications. The resulting thermoplastic starch is noted to be less smoke generating when processing compositions including such a thermoplastic starch component into nonwovens, as well as being significantly more hydrophobic in nature, and exhibiting increased resistance to moisture and humidity, when such glycerides are included. The increased hydrophobicity makes such materials more amenable for blending with polyolefins (which are also generally hydrophobic), or blending with other relatively hydrophobic polymers. For example, favorable interactions of the hydrophobic fatty acid chains may occur with similarly configured polyolefinic chains. Inclusion of other components (e.g., alkyl fatty acids) that similarly include an alkyl chain may provide similar benefits.

Exemplary glycerides that may be used are shown below and in FIG. 8, although the examples shown are of course not exhaustive. In an example, the carbon chain length of the fatty acid chains or residues thereof may be greater than 6, greater than 8, greater than 10, or greater than 12 carbon atoms in length (e.g., 6-30, 6-20, 8-20, 12-30, 12-20, 12-18, or 16-20 or 18-20 carbons, such as 8, 10, 12, 14, 16, 18, 20, 22, 24, 26, 28 or 30 carbon atoms). In an embodiment, where the glyceride is a diglyceride or triglyceride, the 2 or 3 chain lengths on a given diglyceride or triglyceride may be the same or of different lengths. As shown below, the fatty acid chains may be saturated, unsaturated, or polyunsaturated. Unsaturated or polyunsaturated fatty acid chains may include such unsaturation at any desired location along the chain. Non-limiting examples of such include omega-3 structures and/or omega-6 structures.

As with the diacid or acid anhydride, it is important that the glyceride addition occur during manufacture of the thermoplastic starch, before the other polymer material with which the starch-based polymeric material may eventually be blended, is present. In particular, the desired reaction or other incorporation with the glyceride occurs quickly within the extruder or similar system where the thermoplastic starch is formed, while such may not reliably occur in the manner desired, outside the extruder or similar system, and/or in the presence of another polymeric material (i.e., the starch may be the only polymer present).

Oleic acid is exemplary, as a monounsaturated fatty acid, having the following structure.

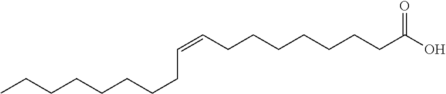 [SMILES: CCCCCCCC/C=C\CCCCCCCC(=O)O]

Stearic acid is exemplary, as a saturated fatty acid, having the following structure.

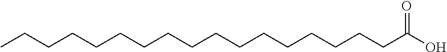 [SMILES: CCCCCCCCCCCCCCCCCC(=O)O]

Linoleic acid is exemplary, as an omega-6 polyunsaturated fatty acid, having the following structure.

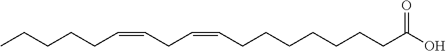 [SMILES: CCCCC/C=C\C/C=C\CCCCCCCC(=O)O]

Linolenic acid is exemplary, as an omega-3 polyunsaturated fatty acid, having the following structure.

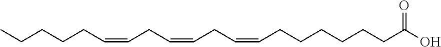 [SMILES: CCCCC/C=C\C/C=C\C/C=C\CCCCCCC(=O)O]

In addition to being exemplary as suitable fatty acids that may be included, such structures (or more accurately the residues thereof) may be present in a mono, di, or triglyceride additive. FIG. 8 further illustrates some exemplary monoglycerides, diglycerides, and triglycerides. It will be appreciated that the structures shown in FIG. 8 are merely exemplary, as the chain lengths on any of the glyceride chains may vary, as noted above, e.g., greater than 6, greater than 8, greater than 10, or greater than 12 carbon atoms in length (e.g., 6-30, 6-20, 8-20, 12-30, 12-20, 12-18, or 16-20 or 18-20 carbons, such as 8, 10, 12, 14, 16, 18, 20, 22, 24, 26, 28 or 30 carbon atoms). The fatty acid chains may be saturated, unsaturated, or polyunsaturated. Unsaturated or polyunsaturated fatty acid chains may include such unsaturation at any desired location along the chain.

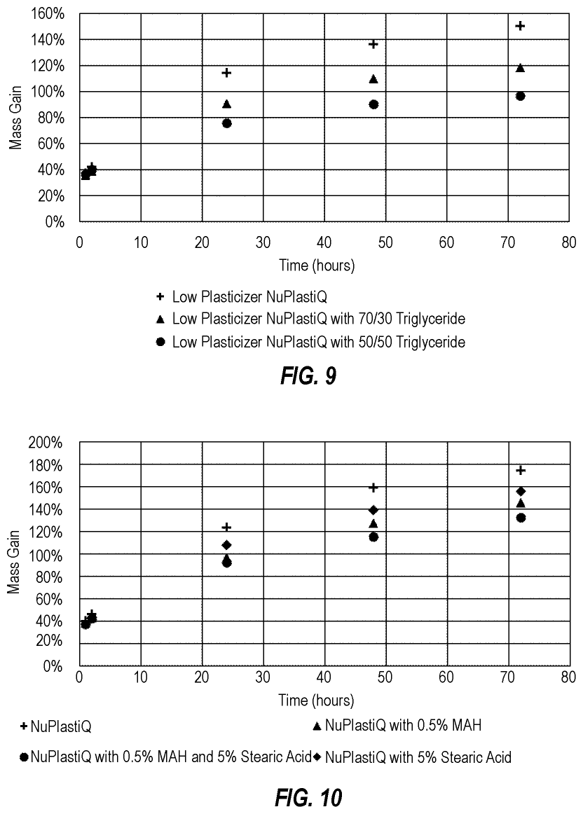

The inclusion of a triglyceride, other glyceride or similar fatty acid component may advantageously be considered to work in tandem with or to be part of the overall plasticizer, further reducing smoke generation that may be due to the lower molecular weight plasticizers, such as glycerin. Sorbitol has a significantly higher molecular weight and lower volatility than glycerin, and also may be advantageous for reducing or eliminating such smoke generation, in addition to or alternative to inclusion of fatty acids, mono, di, or triglycerides for such purpose. In referring to FIG. 9, showing improved moisture resistance, the example labeled “low plasticizer NuPlastiQ with 70/30 triglyceride” was formed from a mixture where the plasticizer (e.g., included in the low amount of 20-25% of the total mixture) included 70% glycerin and 30% triglyceride. Similarly, the example shown in FIG. 9 labeled “low plasticizer NuPlastiQ with 50/50 triglyceride” was formed from a mixture where the plasticizer (e.g., included in the low amount of 20-25% of the total mixture) included 50% glycerin and 50% triglyceride. The example with higher triglyceride exhibits better moisture resistance.

FIGS. 9 and 10 illustrate the improved resistance to humidity and moisture retention provided by such embodiments that include the diacid or acid anhydride, and/or the glyceride or another fatty acid component. In particular, FIGS. 9 and 10 show that when a diacid, acid anhydride, fatty acid or triglyceride is introduced into the starch-based material along with the plasticizer, during the gelatinization process, the resulting thermoplastic starch material is significantly more resistant to moisture absorption. FIG. 10 shows the best results are achieved where both (i) a diacid or acid anhydride and (ii) a fatty acid or triglyceride is included. As starch and thermoplastic starches are typically highly hydrophilic, they tend to absorb moisture quickly. In certain applications, this is not desirable. By introducing diacids, acid anhydrides, hydrophobic fatty acids and/or mono, di and/or triglycerides into the NuPlastiQ synthesis process, the resulting NuPlastiQ becomes less hydrophilic (more hydrophobic). The results in FIGS. 9 and 10 for mass gain (i.e., moisture uptake) were for pellets of the prepared starch-based polymeric material, exposed to 93% relative humidity at 38° C.

In another embodiment a combination of diacids (e.g., alkyl diacids such as malic acid) and a fatty acid/triglyceride were used in conjunction with starch mixtures (50-85% or 65-85% on a dry basis) and glycerin (10-30% or 15-30% on a dry basis), as well as water (e.g., 20-25%). As noted above, while water is present in the initial mixture of components, water within the finished thermoplastic starch material is negligible (e.g., less than 1%). The fractions of starch and plasticizer are reported on a dry basis, excluding the water (which is initially present/added at 20-25% by weight of the overall mixture). A typical formulation measured on not a “dry” basis, before the water is driven off, may include about 70% starch(es), about 20% plasticizer, about 5-10% added water, and about 0.2-5% additive(s). The described embodiments provide improved processability within an extruder or similar system, and the resulting thermoplastic starch material is significantly more hydrophobic, making it more amenable for blending with polyolefins as well as various polyester and other biopolymers. Such can provide for superior nonwovens, fibers and articles formed therefrom. Fatty acids and/or mono, di and/or triglycerides can be incorporated into NuPlastiQ synthesis in the presence or absence of any diacid or acid anhydride component. Inclusion of the diacid or acid anhydride makes the extrusion process much easier, as it results in significantly lower viscosities as shown in the Tables. Table 7 below shows the effect of diacid/acid anhydride and fatty acid/triglyceride addition on the apparent shear viscosity of various exemplary NuPlastiQ starch-based materials according to the present invention. Measurements were made using a Goettfert RG 25 capillary rheometer using a 30 L/D, 1 mm die at 180° C.

TABLE 7

| | | | | ETA | ETA | ETA | ETA | ETA |
|---|---|---|---|---|---|---|---|---|
| | | Plasticizer | | 20 1/s | 100 1/s | 200 1/s | 500 1/s | 1000 1/s |
| Ex. | Starch | amount | Additive | [Pa * s] | [Pa * s] | [Pa * s] | [Pa * s] | [Pa * s] |
| 1 | Corn | Reduced | 0% | 3318 | 1334 | 931 | 554 | 387 |
| 2 | Corn | Reduced | Triglyceride | 3318 | 1334 | 931 | 554 | 387 |
| | | | 1% | | | | | |
| 3 | Corn | Reduced | Triglyceride | 3318 | 1334 | 931 | 554 | 387 |
| | | | 2% | | | | | |
| 4 | Corn | Reduced | Triglyceride | 563 | 73 | 45 | 25 | 20 |
| | | | 1% + 0.2% | | | | | |
| | | | diacid or | | | | | |
| | | | anhydride | | | | | |
| | | | additive | | | | | |

In another embodiment, one or more silicones can be included, e.g., to mitigate glycerin or other plasticizer migration. In such embodiments, hydroxy groups of silicone interact with free glycerin making it less labile. By way of example, one or more silicones may be included in an amount from 0.1% to 5%, or from 1% to 5% by weight. These silicones could be provided as neat liquids or gels, or compounded with silicon oxide, or compounded with polyethylene, polypropylene or another partner resin or material when preparing a master batch (e.g., about 50% silicone/50% silicon oxide, polyethylene, polypropylene or other partner resin or material). Applicant has observed that when silicones are used in combination with NuPlastiQ/polypropylene/compatibilizer, even with a glycerin plasticizer; smoke generation was reduced by as much as 75% (e.g., collected as essentially pure glycerin smoke). Such silicone additives can favorably modify the rheology of the composition as well, depending on the extrusion conditions. In such applications, silicones could be added directly, or a silicone could be masterbatched with another polymer, such as a polyolefin (e.g., PE or PP) or other partner resin with which the starch-based material is eventually to be blended, for final use in an article of manufacture.

An exemplary silicone structure for incorporation into the present compositions is shown below. In an embodiment, the silicone component may have a degree of polymerization (value for n in the exemplary silicone structure shown below) so as to provide a molecular weight of at least 1000, at least 2,000, at least 5000, at least 10,000, no more than 300,000, no more than 200,000, or no more than 100,000 such as from about 1000 to about 300,000, from 2000 to about 300,000, from about 2000 to about 100,000 or from about 100,000 to about 300,000. Molecular weight values of greater than 100,000 may typically be referred to as “high molecular weight” silicone. Typical molecular weight values may include 100,000 or 30,000 or 20,000 or from 1,000 to 10,000.

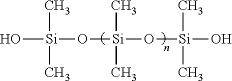

Table 8 below shows the effect of silicone addition on shear viscosity of a blend of NuPlastiQ and PP, as measured using a 30 L/D 1 mm die at 190° C.

TABLE 8

| | | ETA 20 | ETA 200 | ETA 1000 |
|---|---|---|---|---|
| | | 1/s | 1/s | 1/s |
| Sample | Description | [Pa * s] | [Pa * s] | [Pa * s] |
| 210043CP02058 | NPQ/PP nonwoven | 1111 | 306 | 112 |
| | formulation | | | |
| 210043CP02059 | NP/PP nonwoven | 999 | 262 | 98 |
| | formulation w/ | | | |
| | silicone | | | |

The first of the above listed exemplary compositions (which may be considered as a masterbatch formulation) which were prepared included 50% NuPlastiQ starch-based material, 42% of a high melt flow rate polypropylene homopolymer designed for spunbond nonwoven production having an MFI of about 35 g/10 min (according to test method ISO1133), and 8% compatibilizer (e.g., anhydride modified polypropylene). The 2^{nd} listed composition (which also may be considered a masterbatch) included 50% of the same NuPlastiQ starch-based material, 37% of the same high melt flow rate polypropylene homopolymer designed for spunbond nonwoven production having an MFI of about 35 g/10 min (according to test method ISO1133), 8% of the same compatibilizer, and 5% silicone additive.

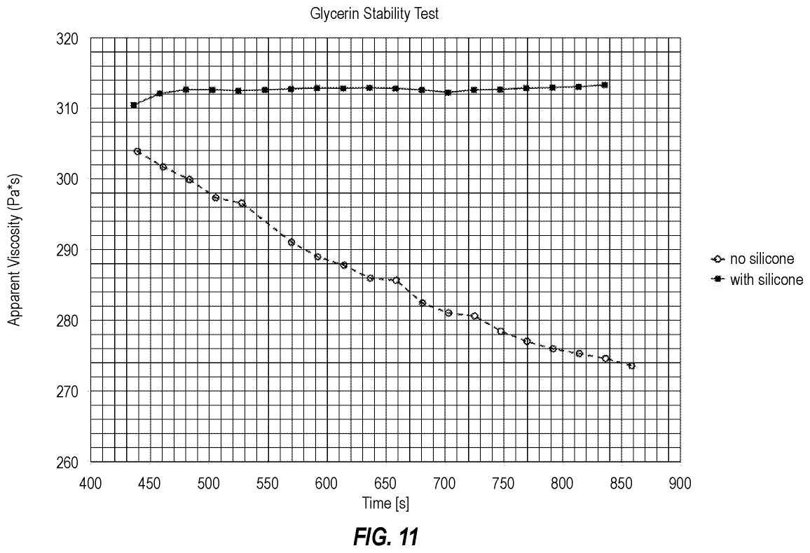

As shown in Table 8, the viscosity values were reduced by about 10-15%, with addition of the silicone component. FIG. 11 shows how such silicone addition greatly enhances the stability of the glycerin within the system, while compositions without silicone addition show changing viscosity over time. In the above example shown in Table 8, the silicone was added after formation of the NuPlastiQ thermoplastic starch, when blending such thermoplastic starch with the polypropylene. Such a silicone component may be included in an amount of at least 0.1%, 0.2% to 10%, 1-8%, 0.1-5%, 1-5%, 0.5%, 1%, 2%, 3%, 4%, 5%, 6%, 7%, 8%, 9%, 10%, or ranges defined between two of any such values, or other amounts as may be apparent.

In another embodiment, silicone is introduced during the manufacturing of the NuPlastiQ starch-based material itself. In a typical experiment, silicone (0.1% to 5% or 1% to 5%) was used in combination with one or more starch mixtures (e.g., 50-85%, or 65-85%), water (10-25%, or 10-20%) and plasticizer (15-30%). As noted previously, the fractions of starch and plasticizer are reported on a dry basis, excluding any water present. Other additives (e.g., diacids, acid anhydrides, fatty acids, and/or glycerides) as described herein can also be included. This mixture is gelatinized/processed in an extruder or similar system as described elsewhere herein to create thermoplastic starch exhibiting favorable rheological properties for nonwoven applications.

Another embodiment employs the use of alkyl diacids, such as DL-Malic acid in combination with glycidyl ethers, particularly diglycidyl ethers. Typical thermoplastic production processes degrade the original starch molecular weight (so that the thermoplastic starch has lower molecular weight as compared to the starting starch). Such original molecular weight values vary widely by starch source, as will be apparent. Many commercially available thermoplastic starches are believed to have an Mw molecular weight of around 1 million, or less. These low molecular weight thermoplastic starches would impart suboptimal mechanical properties for the resulting polymer blends when blended with other hydrocarbon resins (e.g., such as a polyolefin, a polyester, etc.). The NuPlastiQ synthesis process is special in that, it generally preserves, sometimes even increasing starch molecular weight, resulting in a thermoplastic starch that does not significantly degrade the mechanical properties of a blended resin. However, this has historically limited the NuPlastiQ synthesis process to use of a few selected starches, that are high molecular weight, when particular properties are desired.

In an embodiment a diacid such as DL-Malic acid is used to control (e.g., reduce) the molecular weight, while one or more glycidyl ethers (e.g., diglycidyl ethers) are used to build up (e.g., increase) the molecular weight. By doing this applicant is able to make a narrower molecular weight distribution of thermoplastic starch, while keeping the average Mw higher than typical thermoplastic starches (which appear to be around 1 million). In a typical manufacturing process, a variety of alkyl and/or alkenyl diacids or acid anhydrides such as those described herein are included in an amount of 0.01% to 5%, or 0.1% to 5%, in combination with one or more starches included at 50-85% or 65-85%, water included at 10-25% or 10-20%, and glycerin or one or more other plasticizers included at 15-30%, where one or more glycidyl ethers are also included in an amount at 0.01-5% or 0.1-5% by weight. As noted previously, the fractions of starch and plasticizer are reported on a dry basis, excluding any water present. This mixture is gelatinized/processed in an extruder or similar system as described herein, and can be used to create thermoplastic starch of favorable rheological properties for nonwoven applications (e.g., exhibiting rheological properties similar to polypropylenes currently used in such nonwoven applications).

Exemplary diglycidyl ethers are shown below. It will be appreciated that the examples shown are not exhaustive, and other diglycidyl ethers could alternatively be used.

Polypropylene diglycidyl ether has the structure shown below. Values for n in the structures shown below may typically range from 1 to about 10.

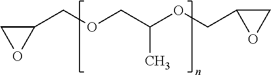

Polyethylene diglycidyl ether has the structure shown below.

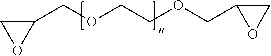

Denacol (Sorbitol glycidyl ether) has the structure shown below.

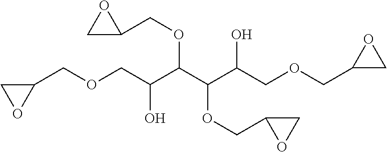 [SMILES: OC(COCC1CO1)C(OCC1CO1)C(OCC1CO1)C(O)COCC1CO1]

The term diglycidyl ether encompasses a tetraglycidyl ether as shown above, as such includes at least two glycidyl ether groups. By way of example, such a glycidyl ether (e.g., diglycidyl ether) may be included in an amount of at least 0.01%, at least 0.1%, at least 0.2%, such as from 0.01% to 5%, 0.1% to 5%, less than 5%, less than 4%, less than 3%, less than 2%, less than 1%, less than 0.5%, such as 0.2% to 0.3% by weight. Exemplary amounts may include 0.01%, 0.05%, 0.1%, 0.2%, 0.3%, 0.4%, 0.5%, 1%, 2%, 3%, 4%, 5%, or ranges defined between any such values. The actual amount included may depend on how many glycidyl ether functional groups are present (e.g., 2, 3, 4 or more, per molecule of additive).

As with the diacid, it is important that any glycidyl ether or diglycyldyl ether be added during synthesis of the NuPlastiQ thermoplastic starch material, (e.g., with the starch, plasticizer, and water, and a diacid or acid anhydride), before blending any such formed thermoplastic starch with another polymer resin material.

Advantages provided by the presently described embodiments include the below.

Addition of diacids under typical NuPlastiQ starch processing conditions (mixture of starches/glycerin/water in extruder mixing at above gelatinization temperatures), reduces the molecular weight of the starting starch or starches. Typical native or modified starches include both amylose (e.g., 20-30%) and amylopectin (e.g., 80-70%). Amylopectin is highly branched and has very high molecular weight, which makes it very shear sensitive. Conducting the gelatinization process in the presence of additives (particularly diacids or acid anhydrides as described herein), narrows the molecular weight distribution, and reduces molecular weight, as confirmed by the measured shear viscosities provided herein. In other words, higher viscosities correlate with higher molecular weight, and increased branching, while lower viscosities correlate with relatively lower molecular weight, and decreased branching.

Depending on the addition level, reduction of molecular weight can be controlled, as observed by the shear viscosity data. The more the additive, the lower the resulting molecular weight.

There is no literature precedence for such degradation of starch in the literature, to the best of applicants knowledge.

When using 1% diacid additive compared to starch alone, applicant obtained a dramatic reduction in the starch molecular weight (perhaps too much-see Table 4). However, when using 0.3% diacid additive, the resulting NuPlastiQ exhibited superior film and article forming properties.

This diacid or acid anhydride additive makes it possible to use combinations of native starches, particularly very high molecular weight potato starches, which are otherwise not usable as a practical matter in many contemplated extruder and similar machines.

Without this diacid or acid anhydride additive and otherwise using the same materials, the resulting NuPlastiQ has very high viscosities (too high) with some very high molecular weight native starches (e.g., very high molecular weight potato starches), which results are not very conducive for blending with polyolefins and various biopolymers. Examples of such are apparent from Table 4.

In addition, the NuPlastiQ made from such native starches without diacid or acid anhydride addition is darker in color (e.g., dark yellow) and possesses some odor. When processed with the diacid additive, the color is lighter, and the odor is reduced or eliminated.

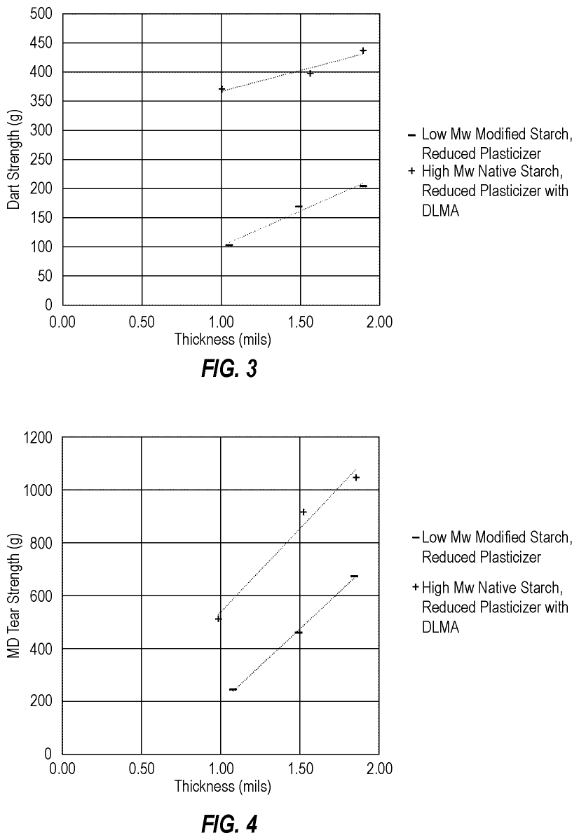

Fibers and nonwovens made with blends of this modified NuPlastiQ blended with polyolefins or other polymers may also possess superior tensile strength, tear strength, and dart strength, as shown in FIGS. 3-7. The blends for which data is shown in FIGS. 3-7 were prepared using 30% of the NuPlastiQ starch-based material, and 70% PBAT, without any compatibilizer.

That said, compatibilizers may be present, in some embodiments. A compatibilizer may optionally be present in the mixture of materials, and is typically provided as a component of the masterbatch, when blending with a partner resin, after the starch-based material has already been formed. The compatibilizer can be a modified polyolefin or other modified polymer, such as a maleic anhydride grafted polyolefin (e.g., a maleic anhydride grafted polyethylene, a maleic anhydride grafted polypropylene, a maleic anhydride grafted polybutene, a maleic anhydride grafted polyolefin copolymer, a combination of any of the foregoing, etc.). The compatibilizer can include an acrylate based co-polymer. For example, the compatibilizer can include an ethylene methyl acrylate co-polymer, an ethylene butyl-acrylate co-polymer, or an ethylene ethyl acrylate co-polymer. The compatibilizer can include a poly(vinylacetate) based compatibilizer. In an embodiment, the compatibilizer may be a grafted version of one of the partner resin with which the starch-based material is being blended (e.g., maleic anhydride grafted polypropylene where the plastic material is polypropylene) or a copolymer (e.g., a block copolymer) where one of the blocks is of the same monomer as the partner resin being blended with (e.g., a styrene copolymer where the thermoplastic material is polystyrene or ABS). Selection of a particular compatibilizer often depends on the identity of the partner resin included in the blend, and the compatibilizer (if even present) can be selected to provide good compatibility results between the starch-based material and whatever particular partner resin the starch-based polymeric material is blended with. When blending with PBAT and similar polyesters, no compatibilizer may be needed.

If present, the final blend may include at least 0.5%, at least 1%, at least 2%, at least 3%, at least 4%, at least 5%, no greater than 50%, no greater than 45%, no greater than 40%, no greater than 35%, no greater than 30%, no greater than 25%, no greater than 20%, no greater than 15%, no greater than 10%, no greater than 9%, no greater than 8%, no greater than 7%, no greater than 6%, from 0.5% by weight to 12%, from 2% to 7%, or from 4% to 6% by weight of a compatibilizer. The masterbatch may include double, or another multiplier, relative to such amounts, depending on the blend ratio of the masterbatch to the partner resin with which it is blended. For example, where the final blend may be desired to include 4% compatibilizer, the masterbatch may include 8% compatibilizer, which is to be downblended at a 1:1 ratio.

As shown in FIG. 3, dart drop impact strength for an approximate 1 mil thick film, when using a NuPlastiQ formed from a low Mw modified starch (e.g., see Table 4) with a reduced amount of plasticizer (e.g., 20-25% plasticizer, such as 23%) is about 100 g (e.g., as tested according to ASTM D-1709) at about 1 mil thick film, and about 200 g at about 2 mil thickness. By using a high Mw starch, with addition of a small amount of DLMA (e.g., about 0.3%), dart drop impact strength increases dramatically, to about 370 g for a film having a thickness of about 1 mil, and about 430 g for a film having a thickness of about 2 mil. Such an increase is dramatic, representing a 100% to 200% increase in dart drop impact strength, depending on thickness. By way of example, such strength characteristics (or others as shown in FIGS. 4-7) may increase by at least 10%, at least 20%, at least 30% at least 40%, at least 50%, at least 100%, at least 150%, or at least 200%. The actual strength values associated with FIG. 3 are also provided in Table 9 below.

TABLE 9

| | Film | Dart |
|---|---|---|
| NuPlastiQ Description for PBAT and | Thickness | Strength |
| NuPlastiQ Film Sample | (mil) | (g) |
| Low Mw Modified Starch, Reduced Plasticizer | 1.1 | 103 |
| | 1.5 | 169 |
| | 1.9 | 205 |
| High Mw Native Starch, Reduced Plasticizer | 1.0 | 371 |
| with DLMA | 1.6 | 398 |
| | 1.9 | 438 |

FIG. 4 is similar to FIG. 3, but shows the increase in MD tear strength (e.g., as measured using an Elmendorf Tear test (ASTM D-1922). MD tear strength increases dramatically, from about 200-250 g to about 510 g, at about 1 mil thickness. At about a 2 mil thickness, the increase is from about 670 g to about 1050 g. By way of example, such strength characteristics may increase by at least 10%, at least 20%, at least 30% at least 40%, at least 50%, at least 100%, at least 150%, or at least 200%. The actual strength values associated with FIG. 4 are also provided in Table 10 below.

TABLE 10

| | Film | MD Tear |
|---|---|---|
| NuPlastiQ Description for PBAT and | Thickness | Strength |
| NuPlastiQ Film Sample | (mil) | (g) |
| Low Mw Modified Starch, Reduced Plasticizer | 1.1 | 245 |
| | 1.5 | 459 |
| | 1.9 | 672 |
| High Mw Native Starch, Reduced Plasticizer | 1.0 | 511 |
| with DLMA | 1.5 | 915 |
| | 1.9 | 1045 |

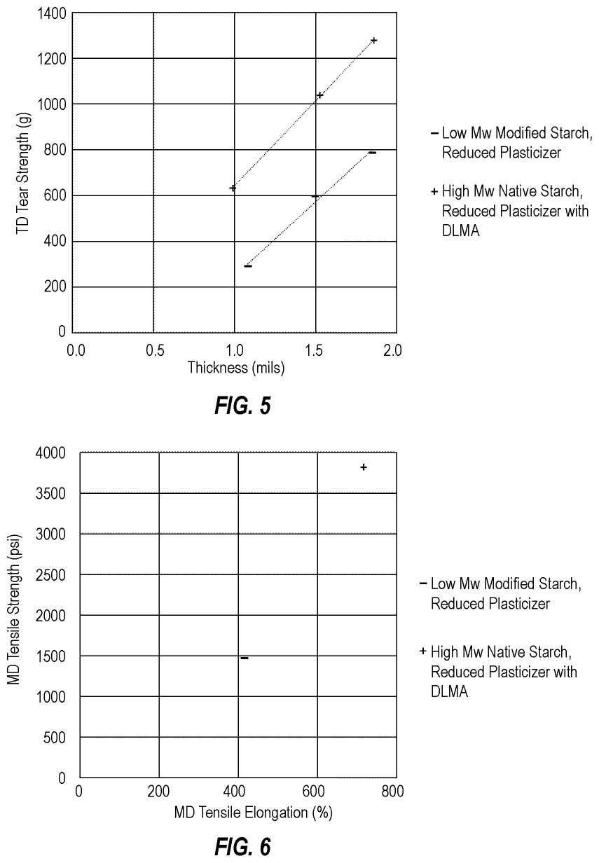

FIG. 5 is similar to FIG. 4, but shows the increase in TD tear strength (e.g., as measured using an Elmendorf Tear test (ASTM D-1922). TD tear strength increases dramatically, from about 250-300 g to about 625 g, at about 1 mil thickness. At about a 2 mil thickness, the increase is from about 800 g to about 1300 g. By way of example, such strength characteristics may increase by at least 10%, at least 20%, at least 30% at least 40%, at least 50%, at least 100%, at least 150%, or at least 200%. The actual strength values associated with FIG. 5 are also provided in Table 11 below.

TABLE 11

| | Film | TD Tear |
|---|---|---|
| NuPlastiQ Description for PBAT and | Thickness | Strength |
| NuPlastiQ Film Sample | (mil) | (g) |
| Low Mw Modified Starch, Reduced Plasticizer | 1.1 | 289 |
| | 1.5 | 597 |
| | 1.9 | 787 |
| High Mw Native Starch, Reduced Plasticizer | 1.0 | 632 |
| with DLMA | 1.5 | 1040 |
| | 1.9 | 1280 |

FIG. 6 shows the increase in MD tensile strength and TD tensile elongation (e.g., as measured using tensile strength and tensile elongation at break tests (ASTM D-882). MD tensile strength increases dramatically, from about 1500 psi to about 3800 psi. MD tensile elongation also increases dramatically, from about 400% to about 700%. By way of example, such strength characteristics may increase by at least 10%, at least 20%, at least 30% at least 40%, at least 50%, at least 100%, at least 150%, or at least 200%. The actual strength values associated with FIG. 6 are also provided in Table 12 below.

TABLE 12

| | MD Tensile | MD Tensile |
|---|---|---|
| NuPlastiQ Description for PBAT and | Strength | Elongation |
| NuPlastiQ Film Sample of ~1 mil thickness | (psi) | (%) |
| Low Mw Modified Starch, Reduced | 1471 | 416 |
| Plasticizer | | |
| High Mw Native Starch, Reduced Plasticizer | 3808 | 718 |
| with DLMA | | |

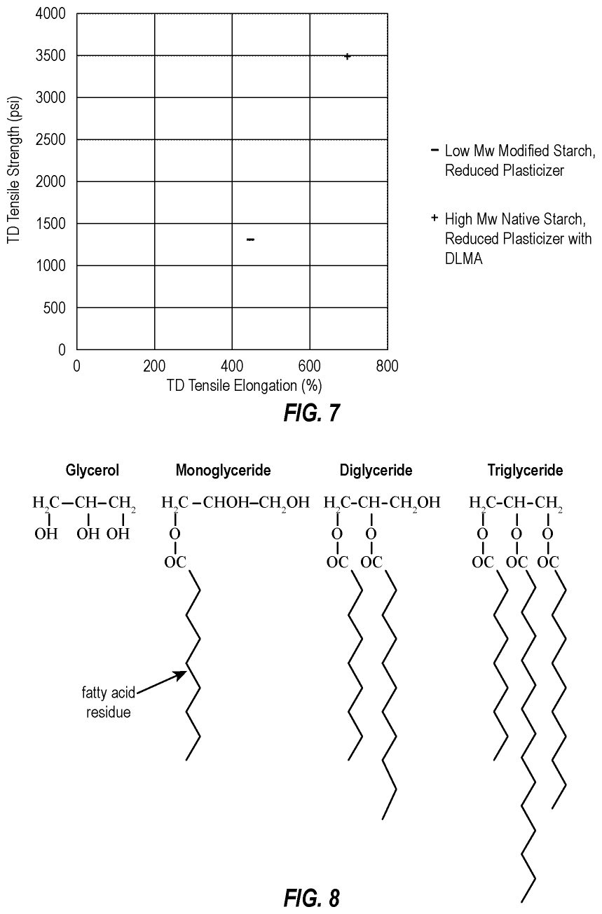

FIG. 7 shows the increase in TD tensile strength and TD tensile elongation (e.g., as measured using tensile strength and tensile elongation at break tests (ASTM D-882). TD tensile strength increases dramatically, from about 1300 psi to about 3500 psi. TD tensile elongation also increases dramatically, from about 440% to about 700%. By way of example, such strength characteristics may increase by at least 10%, at least 20%, at least 30% at least 40%, at least 50%, at least 100%, at least 150%, or at least 200%. The actual strength values associated with FIG. 7 are also provided in Table 13 below.

TABLE 13

| | TD Tensile | TD Tensile |
|---|---|---|
| NuPlastiQ Description for PBAT and | Strength | Elongation |
| NuPlastiQ Film Sample of ~1 mil thickness | (psi) | (%) |
| Low Mw Modified Starch, Reduced | 1314 | 447 |
| Plasticizer | | |
| High Mw Native Starch, Reduced Plasticizer | 3494 | 697 |
| with DLMA | | |

Inclusion of diacids also results in decreased water content for the resulting NuPlastiQ, e.g., from a typical value of 1% to 1.2% to less than 0.8%, or less than 0.5% water content (e.g., as measured by weight loss upon drying).

When stearic acid, other fatty acids, or triglycerides (oils) were added, the resulting NuPlastiQ is significantly more hydrophobic, with much more resistance against humidity exposure. The addition of the diacid or acid anhydride alone even provides some improvement against moisture absorption (see FIG. 10). The addition of both the diacid or acid anhydride and a fatty acid or fatty glyceride component seems to provide the best resistance against moisture absorption.

Combined use of one or more diacids or acid anhydrides, with a fatty acid or triglyceride can be used to modify the rheology of the resulting NuPlastiQ thermoplastic starch, e.g., to match rheology of a polypropylene composition suitable for nonwoven formation.

When a diacid or acid anhydride is used in combination with one or more glycidyl ethers, the diacid or acid anhydride reduces the molecular weight for the starch, while the glycidyl ethers cross-link the starch chains to build the molecular weight back up, as evidenced by the rheological data as listed in Table 2 (where several examples included DENACOL, as a diglycidyl ether additive).

Silicones were successfully used to control the smoke generation issue caused by free glycerin. Silicones interact/react with free glycerin, making it less volatile and stable in high shear nonwoven processes.

It will be appreciated that in describing thermoplastic starch-based materials including any particular components (e.g., a diacid, an acid anhydride, a silicone, a diglycidyl ether, etc.), where such components are added to the components from which the thermoplastic starch-based material is formed, any of various reactions may occur, which may result in incorporation of such components (or residues thereof) within the thermoplastic starch-based material. Such incorporation or residues are within the scope of the present claims as contemplated, where the claims may specify that such components are present in the finished thermoplastic starch-based material, or that the starch-based material is formed from such materials.

The present invention can be embodied in other specific forms without departing from its spirit or essential characteristics. Thus, the described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A thermoplastic starch-based material formed from:
one or more starches, the starches being present in an amount of from about 50% to about 85% by weight of the starch-based material;
one or more plasticizers comprising at least one of glycerin, sorbitol, maltitol, or propane diol, the one or more plasticizers being present in an amount of from about 15% to about 30% by weight of the starch-based material; and
at least one of (i) or (ii):
(i) a silicone present in an amount of from about 0.1% to about 5% by weight of the starch-based material, addition of the silicone providing the thermoplastic starch-based material with decreased smoke generation during formation of melt spun fibers and nonwovens from such thermoplastic starch-based material;
(ii) a glyceride present in an amount of from about 1% to about 10% by weight, the glyceride addition providing the thermoplastic starch-based material with increased hydrophobicity.

2. The thermoplastic starch-based material of claim 1, wherein both (i) and (ii) are present.

3. The thermoplastic starch-based material of claim 2, wherein the glyceride comprises a triglyceride.

4. The thermoplastic starch-based material of claim 2, wherein the glyceride comprises a fatty acid residue.

5. The thermoplastic starch-based material of claim 1, wherein the thermoplastic starch-based material comprises the silicone present in an amount of from about 0.1% to about 5% by weight of the starch-based material, addition of the silicone providing the thermoplastic starch-based material with decreased smoke generation during formation of melt spun fibers and nonwovens from such thermoplastic starch-based material.

6. The thermoplastic starch-based material of claim 1, wherein the thermoplastic starch-based material comprises the glyceride present in an amount of from about 1% to about 10% by weight, the glyceride addition providing the thermoplastic starch-based material with increased hydrophobicity.

7. The thermoplastic starch-based material of claim 1, further comprising a diacid or corresponding acid anhydride, and/or a diglycidyl ether present in an amount of from about 0.01% to about 5% by weight of the starch-based material.

8. The thermoplastic starch-based material of claim 1, further comprising a diacid or corresponding acid anhydride and/or a diglycidyl ether present in an amount of from about 0.1% to about 0.5% by weight of the starch-based material.

9. The thermoplastic starch-based material of claim 1, further comprising a diacid or corresponding acid anhydride, and a diglycidyl ether, each of the diacid or corresponding acid anhydride and the diglycidyl ether being present in an amount of from about 0.01% to about 5% by weight of the starch-based material.

10. The thermoplastic starch-based material of claim 1, wherein the one or more plasticizers comprise at least one of glycerin, sorbitol, maltitol, or propane diol.

11. The thermoplastic starch-based material of claim 1, wherein the one or more plasticizers comprises sorbitol and are substantially or entirely void of glycerin.

12. The thermoplastic starch-based material of claim 1, further comprising a diacid or corresponding acid anhydride in an amount of from about 0.01% to about 5% by weight of the starch-based material.

13. The thermoplastic starch-based material of claim 12, wherein the diacid or corresponding acid anhydride is present in an amount of no more than about 0.5% by weight of the starch-based material.

14. The thermoplastic starch-based material of claim 12, wherein the diacid or corresponding acid anhydride is present in an amount of from about 0.2% to about 0.3% by weight of the starch-based material.

15. The thermoplastic starch-based material of claim 12, wherein the thermoplastic starch-based material includes less than 0.8% water content, attributable to the diacid or corresponding acid anhydride.

16. The thermoplastic starch-based material of claim 1, further comprising a diglycidyl ether.

17. The thermoplastic starch-based material of claim 16, wherein the diglycidyl ether is present in an amount of from about 0.1% to about 5% by weight of the starch-based material.

18. The thermoplastic starch-based material of claim 16, wherein the diglycidyl ether is present in an amount of no more than about 0.5% by weight of the starch-based material.

19. The thermoplastic starch-based material of claim 16, wherein the diglycidyl ether is present in an amount of from about 0.2% to about 0.3% by weight of the starch-based material.

20. A blend including the thermoplastic starch-based material of claim 1, wherein the thermoplastic starch-based material is blended with at least one of PLA, PBAT, PBS, PHA, another polyester, a polyamide, a polyolefin or polystyrene.
